(19) United States
(12) Patent Application Publication
(10) Pub. No.: US 2023/0186193 A1
(43) Pub. Date: Jun. 15, 2023

(54) SYSTEMS AND METHODS FOR INTELLIGENTLY AUGMENTING A NEW TASK

(71) Applicant: Citrix Systems, Inc., Fort Lauderdale, FL (US)

(72) Inventors: Ze Chen, Nanning (CN); Zongpeng Qiao, Nanjing (CN); Xiao Zhang, Nanjing (CN)

(21) Appl. No.: 17/648,215

(22) Filed: Jan. 18, 2022

Related U.S. Application Data
(63) Continuation of application No. PCT/CN2021/136681, filed on Dec. 9, 2021.

(51) Int. Cl. G06Q 10/06

(52) U.S. Cl. CPC G06Q 10/063112; G06Q 10/06313

(57) ABSTRACT

In one aspect, an example methodology implementing the disclosed techniques can include, by a first computing device, receiving information regarding a new task to be performed by a user and extracting one or more keywords from the information regarding the new task. The method can also include, by the first computing device, identifying one or more resources relevant to the new task based on relevancy scores, a relevancy score for a resource indicative of the relevancy of the one or more keywords to the resource. The method can further include, by the first computing device, sending information regarding the one or more resources relevant to the new task to a second computing device, the second computing device configured to augment the new task with the information regarding the one or more resources relevant to the new task.

### CROSS REFERENCE TO RELATED APPLICATIONS

This application is a continuation of and claims the benefit of PCT Pat. Application No. PCT/CN2021/136681 filed on Dec. 9, 2021 in the English language in the State Intellectual Property Office and designating the United States, the contents of which are hereby incorporated herein by reference in its entirety.

### BACKGROUND

Organizations work on many projects at the same time. Many of these projects may be large projects that involve a number of smaller tasks which need to be assigned and performed for the successful completion of a project. For example, within a company, employees may be assigned various tasks based on their skill sets. As the projects become larger and more complex, the task assignments may lack the information to allow the employees assigned to the tasks to efficiently complete the assigned tasks.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

It is appreciated herein that it can be very difficult and/or time consuming to gather information that may be useful in efficiently completing a task. For example, a task assignment may contain only the basic information regarding the task being assigned such as a name and contact information of the person assigning the task (i.e., the assignor), a task due date, and a description of the task (i.e., a description of what is being requested to be performed). In some cases, a minimal amount of additional information, such as a few emails and/or messages related to the task that is being assigned, may be provided by the task assignor with the task assignment. However, the information in the task assignment and the minimal additional information that is provided to the assignee may not be adequate to allow the assignee to efficiently complete the assigned task. As a result, it may be necessary for the assignee to spend time and, in some cases a significant amount of time searching for information, such as background information, related materials, and/or mentors (e.g., experts), that may be helpful to the assignee in efficiently completing the assigned task.

The present disclosure relates to concepts, devices, systems, methods and techniques for automatically collecting documents, files, records, and other items of data (generally referred to herein as “items”) and, from the collected items, augmenting a new task with information regarding resources that are relevant to the new task. The items can be collected from various data sources and analyzed to ascertain or otherwise determine the resources such as persons, documents, files, and computer or source code, to provide some examples. The resources that are relevant to a new task can be identified based on relevancy scores of the resources. The new task can then be augmented with the information regarding the resources that are relevant to the new task (e.g., information regarding the relevant resources can be included in or with a task ticket corresponding to the new task). The information regarding the relevant resources can be presented with the new task in an organized, accessible manner, thereby reducing (and ideally eliminating) the need for a user who is assigned the new task to search for relevant resources. The concepts and techniques described herein can be used to improve the efficiency and utility of existing computer systems and applications, such as existing project management applications (e.g., CITRIX WRIKE).

In accordance with one example embodiment provided to illustrate the broader concepts, systems, and techniques described herein, a method includes, by a first computing device, receiving information regarding a new task to be performed by a user and extracting one or more keywords from the information regarding the new task. The method also includes, by the first computing device, identifying one or more resources relevant to the new task based on relevancy scores, a relevancy score for a resource indicative of the relevancy of the one or more keywords to the resource. The method further includes, by the first computing device, sending information regarding the one or more resources relevant to the new task to a second computing device, the second computing device configured to augment the new task with the information regarding the one or more resources relevant to the new task.

According to another illustrative embodiment provided to illustrate the broader concepts described herein, a system includes a processor and a non-volatile memory storing computer program code. The computer program code, when executed on the processor, causes the processor to execute a process operable to receive information regarding a new task to be performed by a user and extract one or more keywords from the information regarding the new task. The process is also operable to identify one or more resources relevant to the new task based on relevancy scores, a relevancy score for a resource indicative of the relevancy of the one or more keywords to the resource. The process is further operable to send information regarding the one or more resources relevant to the new task to another computing device, the another computing device configured to augment the new task with the information regarding the one or more resources relevant to the new task.

According to another illustrative embodiment provided to illustrate the broader concepts described herein, a method includes, by a first computing device, sending information regarding a new task that is to be performed by a user to a second computing device and receiving information regarding one or more resources relevant to the new task from the second computing device. The one or more resources relevant to the new task are identified based on relevancy scores, a relevancy score for a resource indicative of the relevancy of one or more keywords to the resource, and the one or more keywords extracted from the information regarding the new task. The method also includes, by the first computing device, augmenting the new task with the information regarding the one or more resources relevant to the new task.

According to another illustrative embodiment provided to illustrate the broader concepts described herein, a system includes a processor and a non-volatile memory storing computer program code. The computer program code, when executed on the processor, causes the processor to execute a process operable to send information regarding a new task that is to be performed by a user to another computing device. The process is also operable to receive information regarding one or more resources relevant to the new task from the second computing device, wherein the one or more resources relevant to the new task are identified based on relevancy scores, a relevancy score for a resource indicative of the relevancy of one or more keywords to the resource, the one or more keywords extracted from the information regarding the new task. The process is further operable to augment the new task with the information regarding the one or more resources relevant to the new task.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4A is a block diagram of an illustrative system in which resource management services may manage and streamline access by clients to resource feeds (via one or more gateway services) and/or software-as-a-service (SaaS) applications.

FIG. 4B is a block diagram showing an illustrative implementation of the system shown in FIG. 4A in which various resource management services as well as a gateway service are located within a cloud computing environment.

FIG. 4C is a block diagram similar to FIG. 4B but in which the available resources are represented by a single box labeled “systems of record,” and further in which several different services are included among the resource management services.

FIG. 5 is a block diagram of an illustrative system for intelligent augmentation of a new task, in accordance with an embodiment of the present disclosure.

FIG. 6 shows an example of a user interface (Ul) that may be used to present information regarding resources that are relevant to a new task, in accordance with an embodiment of the present disclosure.

FIG. 7 is a diagram illustrating a portion of a data structure that can be used to store information about collected items, in accordance with an embodiment of the present disclosure.

FIG. 8 is a diagram illustrating a portion of a data structure that can be used to store information about resources, in accordance with an embodiment of the present disclosure.

FIG. 9 is a diagram illustrating a database schema that can be used to store keywords and relevancy scores, in accordance with an embodiment of the present disclosure.

FIG. 10 is a sequence diagram showing an example flow of interactions between various components to collect information regarding resources for use in augmenting a new task, in accordance with an embodiment of the present disclosure.

FIG. 11 is a sequence diagram showing an example flow of interactions between various components to augment a new task with information regarding resources relevant to the new task, in accordance with an embodiment of the present disclosure.

### DETAILED DESCRIPTION

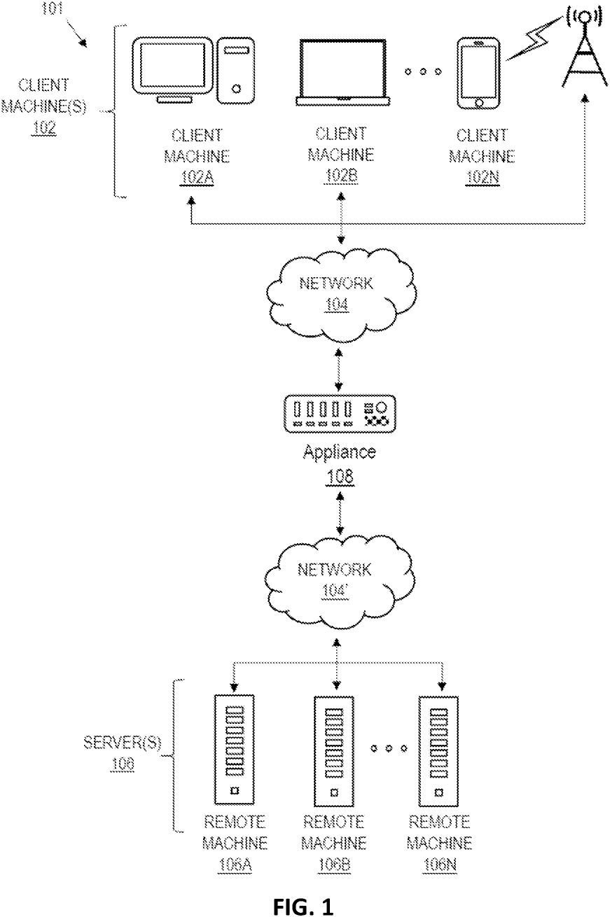

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

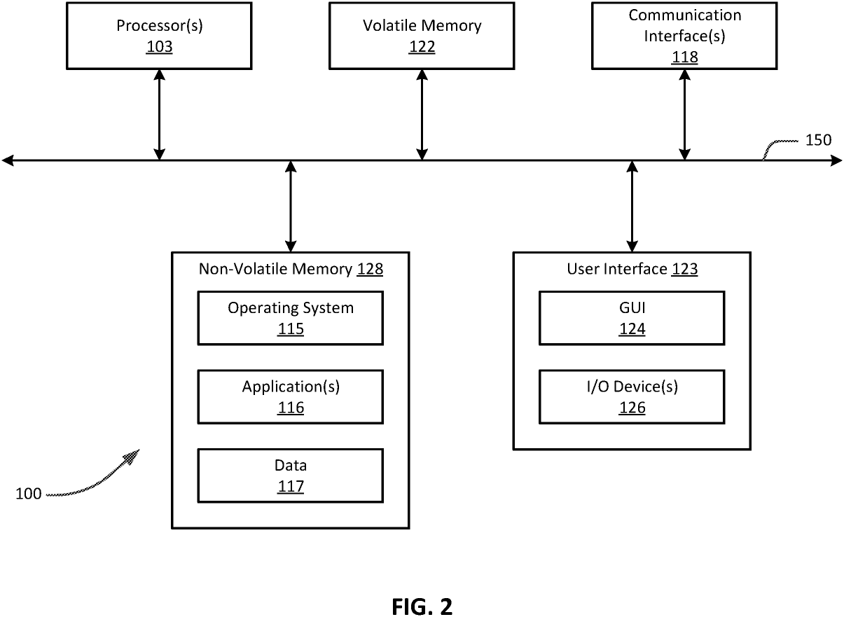

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

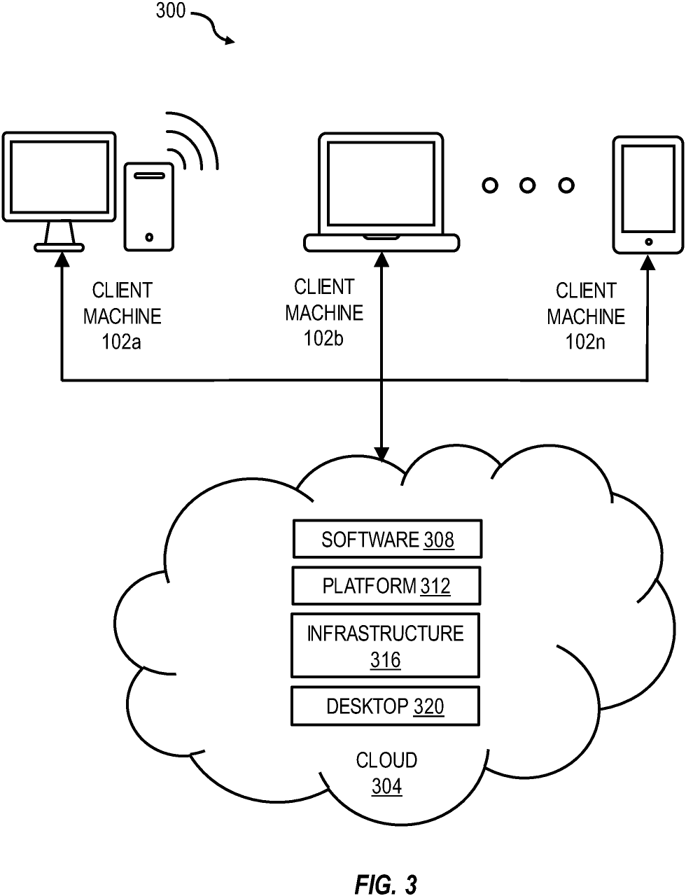

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (laaS) 316, and Desktop as a Service (DaaS) 320, for example. laaS may refer to a user renting the use of infrastructure resources that are needed during a specified time period. laaS providers may offer storage, networking, servers or virtualization resources from large pools, allowing the users to quickly scale up by accessing more resources as needed. Examples of laaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by laaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

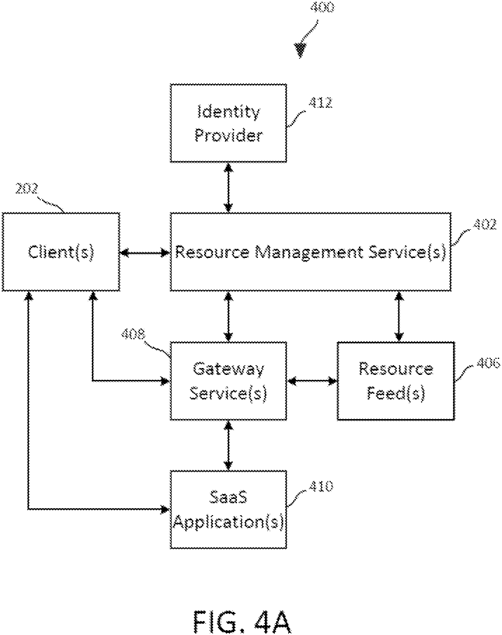

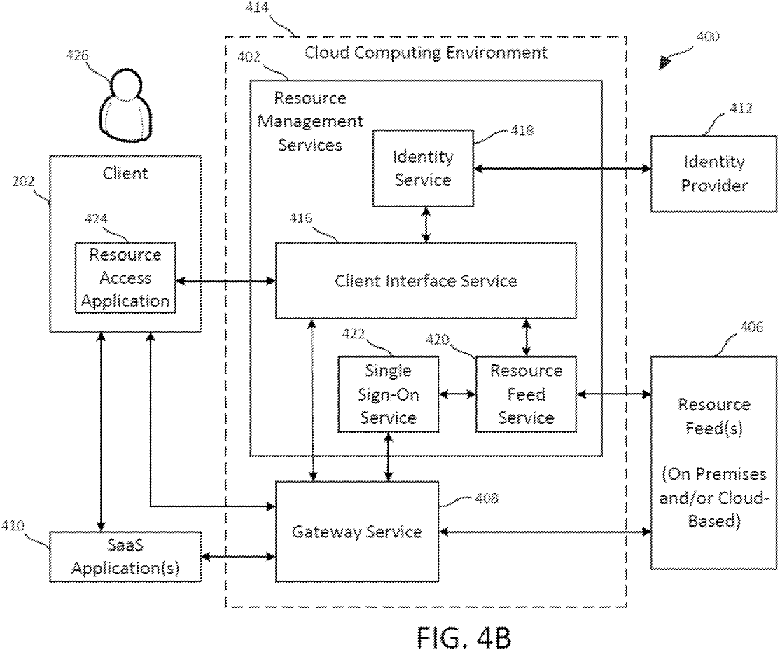

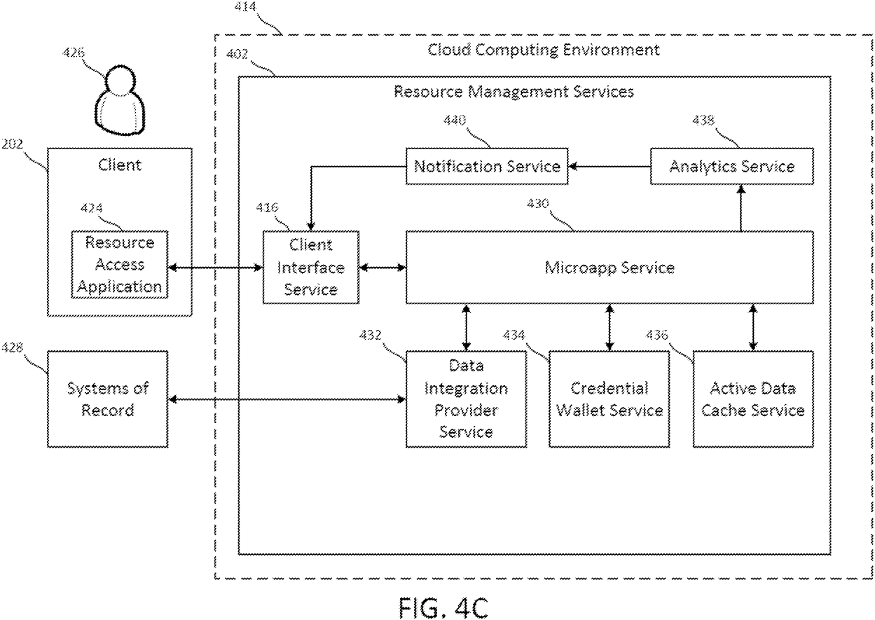

FIG. 4A is a block diagram of an illustrative system 400 in which one or more resource management services 402 may manage and streamline access by one or more clients 202 to one or more resource feeds 406 (via one or more gateway services 408) and/or one or more software-as-a-service (SaaS) applications 410. In particular, resource management service(s) 402 may employ an identity provider 412 to authenticate the identity of a user of a client 202 and, following authentication, identify one of more resources the user is authorized to access. In response to the user selecting one of the identified resources, resource management service(s) 402 may send appropriate access credentials to the requesting client 202, and the requesting client 202 may then use those credentials to access the selected resource. For resource feed(s) 406, client 202 may use the supplied credentials to access the selected resource via gateway service 408. For SaaS application(s) 410, client 202 may use the credentials to access the selected application directly.

Client(s) 202 may be any type of computing devices capable of accessing resource feed(s) 406 and/or SaaS application(s) 410, and may, for example, include a variety of desktop or laptop computers, smartphones, tablets, etc. Resource feed(s) 406 may include any of numerous resource types and may be provided from any of numerous locations. In some embodiments, for example, resource feed(s) 406 may include one or more systems or services for providing virtual applications and/or desktops to client(s) 202, one or more file repositories and/or file sharing systems, one or more secure browser services, one or more access control services for SaaS applications 410, one or more management services for local applications on client(s) 202, one or more internet enabled devices or sensors, etc. Each of resource management service(s) 402, resource feed(s) 406, gateway service(s) 408, SaaS application(s) 410, and identity provider 412 may be located within an on-premises data center of an organization for which system 400 is deployed, within one or more cloud computing environments, or elsewhere.

FIG. 4B is a block diagram showing an illustrative implementation of system 400 shown in FIG. 4A in which various resource management services 402 as well as gateway service 408 are located within a cloud computing environment 414. The cloud computing environment may, for example, include Microsoft Azure Cloud, Amazon Web Services, Google Cloud, or IBM Cloud.

For any of illustrated components (other than client 202) that are not based within cloud computing environment 414, cloud connectors (not shown in FIG. 4B) may be used to interface those components with cloud computing environment 414. Such cloud connectors may, for example, run on Windows Server instances hosted in resource locations and may create a reverse proxy to route traffic between the site(s) and cloud computing environment 414. In the illustrated example, the cloud-based resource management services 402 include a client interface service 416, an identity service 418, a resource feed service 420, and a single sign-on service 422. As shown, in some embodiments, client 202 may use a resource access application 424 to communicate with client interface service 416 as well as to present a user interface on client 202 that a user 426 can operate to access resource feed(s) 406 and/or SaaS application(s) 410. Resource access application 424 may either be installed on client 202 or may be executed by client interface service 416 (or elsewhere in system 400) and accessed using a web browser (not shown in FIG. 4B) on client 202.

As explained in more detail below, in some embodiments, resource access application 424 and associated components may provide user 426 with a personalized, all-in-one interface enabling instant and seamless access to all the user’s SaaS and web applications, files, virtual Windows applications, virtual Linux applications, desktops, mobile applications, Citrix Virtual Apps and Desktops™, local applications, and other data.

When resource access application 424 is launched or otherwise accessed by user 426, client interface service 416 may send a sign-on request to identity service 418. In some embodiments, identity provider 412 may be located on the premises of the organization for which system 400 is deployed. Identity provider 412 may, for example, correspond to an on-premises Windows Active Directory. In such embodiments, identity provider 412 may be connected to the cloud-based identity service 418 using a cloud connector (not shown in FIG. 4B), as described above. Upon receiving a sign-on request, identity service 418 may cause resource access application 424 (via client interface service 416) to prompt user 426 for the user’s authentication credentials (e.g., username and password). Upon receiving the user’s authentication credentials, client interface service 416 may pass the credentials along to identity service 418, and identity service 418 may, in turn, forward them to identity provider 412 for authentication, for example, by comparing them against an Active Directory domain. Once identity service 418 receives confirmation from identity provider 412 that the user’s identity has been properly authenticated, client interface service 416 may send a request to resource feed service 420 for a list of subscribed resources for user 426.

In other embodiments (not illustrated in FIG. 4B), identity provider 412 may be a cloud-based identity service, such as a Microsoft Azure Active Directory. In such embodiments, upon receiving a sign-on request from client interface service 416, identity service 418 may, via client interface service 416, cause client 202 to be redirected to the cloud-based identity service to complete an authentication process. The cloud-based identity service may then cause client 202 to prompt user 426 to enter the user’s authentication credentials. Upon determining the user’s identity has been properly authenticated, the cloud-based identity service may send a message to resource access application 424 indicating the authentication attempt was successful, and resource access application 424 may then inform client interface service 416 of the successfully authentication. Once identity service 418 receives confirmation from client interface service 416 that the user’s identity has been properly authenticated, client interface service 416 may send a request to resource feed service 420 for a list of subscribed resources for user 426.

For each configured resource feed, resource feed service 420 may request an identity token from single sign-on service 422. Resource feed service 420 may then pass the feed-specific identity tokens it receives to the points of authentication for the respective resource feeds 406. Each resource feed 406 may then respond with a list of resources configured for the respective identity. Resource feed service 420 may then aggregate all items from the different feeds and forward them to client interface service 416, which may cause resource access application 424 to present a list of available resources on a user interface of client 202. The list of available resources may, for example, be presented on the user interface of client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on client 202, and/or one or more SaaS applications 410 to which user 426 has subscribed. The lists of local applications and SaaS applications 410 may, for example, be supplied by resource feeds 406 for respective services that manage which such applications are to be made available to user 426 via resource access application 424. Examples of SaaS applications 410 that may be managed and accessed as described herein include Microsoft Office 365 applications, SAP SaaS applications, Workday applications, etc.

For resources other than local applications and SaaS application(s) 410, upon user 426 selecting one of the listed available resources, resource access application 424 may cause client interface service 416 to forward a request for the specified resource to resource feed service 420. In response to receiving such a request, resource feed service 420 may request an identity token for the corresponding feed from single sign-on service 422. Resource feed service 420 may then pass the identity token received from single sign-on service 422 to client interface service 416 where a launch ticket for the resource may be generated and sent to resource access application 424. Upon receiving the launch ticket, resource access application 424 may initiate a secure session to gateway service 408 and present the launch ticket. When gateway service 408 is presented with the launch ticket, it may initiate a secure session to the appropriate resource feed and present the identity token to that feed to seamlessly authenticate user 426. Once the session initializes, client 202 may proceed to access the selected resource.

When user 426 selects a local application, resource access application 424 may cause the selected local application to launch on client 202. When user 426 selects SaaS application 410, resource access application 424 may cause client interface service 416 request a one-time uniform resource locator (URL) from gateway service 408 as well a preferred browser for use in accessing SaaS application 410. After gateway service 408 returns the one-time URL and identifies the preferred browser, client interface service 416 may pass that information along to resource access application 424. Client 202 may then launch the identified browser and initiate a connection to gateway service 408. Gateway service 408 may then request an assertion from single sign-on service 422. Upon receiving the assertion, gateway service 408 may cause the identified browser on client 202 to be redirected to the logon page for identified SaaS application 410 and present the assertion. The SaaS may then contact gateway service 408 to validate the assertion and authenticate user 426. Once the user has been authenticated, communication may occur directly between the identified browser and the selected SaaS application 410, thus allowing user 426 to use client 202 to access the selected SaaS application 410.

In some embodiments, the preferred browser identified by gateway service 408 may be a specialized browser embedded in resource access application 424 (when the resource application is installed on client 202) or provided by one of the resource feeds 406 (when resource access application 424 is located remotely), e.g., via a secure browser service. In such embodiments, SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have client interface service 416 send the link to a secure browser service, which may start a new virtual browser session with client 202, and thus allow the user to access the potentially harmful linked content in a safe environment.

In some embodiments, in addition to or in lieu of providing user 426 with a list of resources that are available to be accessed individually, as described above, user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user’s feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify user 426 of something that requires the user’s attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 4C may enable the provision of a streamlined resource activity feed and/or notification process for client 202. In the example shown, in addition to client interface service 416 discussed above, the illustrated services include a microapp service 430, a data integration provider service 432, a credential wallet service 434, an active data cache service 436, an analytics service 438, and a notification service 440. In various embodiments, the services shown in FIG. 4C may be employed either in addition to or instead of the different services shown in FIG. 4B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within resource access application 424 without having to launch the native application. The system shown in FIG. 4C may, for example, aggregate relevant notifications, tasks, and insights, and thereby give user 426 a dynamic productivity tool. In some embodiments, the resource activity feed may be intelligently populated by utilizing machine learning and artificial intelligence (Al) algorithms. Further, in some implementations, microapps may be configured within cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, systems of record 428 may represent the applications and/or other resources resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. Resource management services 402, and in particular data integration provider service 432, may, for example, support REST API, JSON, OData-JSON, and 6ML. As explained in more detail below, data integration provider service 432 may also write back to the systems of record, for example, using OAuth2 or a service account.

In some embodiments, microapp service 430 may be a single-tenant service responsible for creating the microapps. Microapp service 430 may send raw events, pulled from systems of record 428, to analytics service 438 for processing. The microapp service may, for example, periodically pull active data from systems of record 428.

In some embodiments, active data cache service 436 may be single-tenant and may store all configuration information and microapp data. It may, for example, utilize a per-tenant database encryption key and per-tenant database credentials.

In some embodiments, credential wallet service 434 may store encrypted service credentials for systems of record 428 and user OAuth2 tokens.

In some embodiments, data integration provider service 432 may interact with systems of record 428 to decrypt end-user credentials and write back actions to systems of record 428 under the identity of the end-user. The write-back actions may, for example, utilize a user’s actual account to ensure all actions performed are compliant with data policies of the application or other resource being interacted with.

In some embodiments, analytics service 438 may process the raw events received from microapps service 430 to create targeted scored notifications and send such notifications to notification service 440.

Finally, in some embodiments, notification service 440 may process any notifications it receives from analytics service 438. In some implementations, notification service 440 may store the notifications in a database to be later served in a notification feed. In other embodiments, notification service 440 may additionally or alternatively send the notifications out immediately to client 202 as a push notification to user 426.

In some embodiments, a process for synchronizing with systems of record 428 and generating notifications may operate as follows. Microapp service 430 may retrieve encrypted service account credentials for systems of record 428 from credential wallet service 434 and request a sync with data integration provider service 432. Data integration provider service 432 may then decrypt the service account credentials and use those credentials to retrieve data from systems of record 428. Data integration provider service 432 may then stream the retrieved data to microapp service 430. Microapp service 430 may store the received systems of record data in active data cache service 436 and also send raw events to analytics service 438. Analytics service 438 may create targeted scored notifications and send such notifications to notification service 440. Notification service 440 may store the notifications in a database to be later served in a notification feed and/or may send the notifications out immediately to client 202 as a push notification to user 426.

In some embodiments, a process for processing a user-initiated action via a microapp may operate as follows. Client 202 may receive data from microapp service 430 (via client interface service 416) to render information corresponding to the microapp. Microapp service 430 may receive data from active data cache service 436 to support that rendering. User 426 may invoke an action from the microapp, causing resource access application 424 to send that action to microapp service 430 (via client interface service 416). Microapp service 430 may then retrieve from credential wallet service 434 an encrypted Oauth2 token for the system of record for which the action is to be invoked and may send the action to data integration provider service 432 together with the encrypted Oath2 token. Data integration provider service 432 may then decrypt the Oath2 token and write the action to the appropriate system of record under the identity of user 426. Data integration provider service 432 may then read back changed data from the written-to system of record and send that changed data to microapp service 430. Microapp service 432 may then update active data cache service 436 with the updated data and cause a message to be sent to resource access application 424 (via client interface service 416) notifying user 426 that the action was successfully completed.

In some embodiments, in addition to or in lieu of the functionality described above, resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, resource management services 402 may enable virtual assistance functionality that allows users to remain productive and take quick actions. Users may, for example, interact with the “Virtual Assistant” and ask questions such as “What is Bob Smith’s phone number?” or “What absences are pending my approval?” Resource management services 402 may, for example, parse these requests and respond because they are integrated with multiple systems on the backend. In some embodiments, users may be able to interact with the virtual assistance through either resource access application 424 or directly from another resource, such as Microsoft Teams. This feature may allow employees to work efficiently, stay organized, and deliver only the specific information they’re looking for.

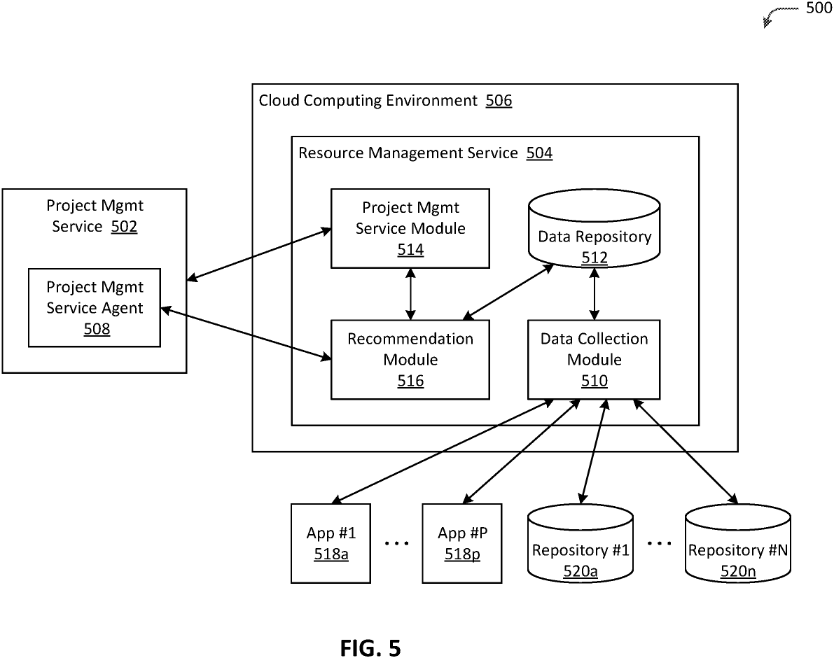

FIG. 5 is a block diagram of an illustrative system 500 for intelligent augmentation of a new task, in accordance with an embodiment of the present disclosure. System 500 includes a project management service 502 configured to communicate with a resource management service 504 within a cloud computing environment 506. Project management services 502, resource management service 504, and cloud computing environment 506 of FIG. 5 can be the same as or similar to SaaS applications 410, resource management service 402, and cloud computing environment 414, respectively, of FIGS. 4A-4C.

As shown in FIG. 5, a project management service agent 508 can be provided as a sub-module or other component of project management service 502. Project management service 502, project management service agent 508, and resource management service 504 can interoperate to augment a new task created in project management service 502 with information regarding one or more resources that are relevant to the new task. The information regarding the resources that are relevant to the new task can be presented in an organized, accessible manner to a user who is assigned the new task to assist the user in performing the assigned task, for example.

To promote clarity in the drawings, FIG. 5 shows a single project management service 502 communicably coupled to resource management service 504. However, embodiments of resource management service 504 can be used to service many project management services 502 used by many different users associated with one or more organizations. Project management service 502, project management service agent 508, and/or resource management service 504 may be implemented as computer instructions executable to perform the corresponding functions disclosed herein. Resource management service 504 can be logically and/or physically organized into one or more components. In the example of FIG. 5, resource management service 504 includes a data collection module 510, a data repository 512, a project management service module 514, and a recommendation module 516.

Project management service 502 can communicate with resource management service 504 using an API (e.g., a SaaS API). For example, project management service 502 can send API messages to resource management service 504 wherein the API messages are received and processed by project management service module 514. Similarly, recommendation module 516 can send API messages to project management service 502 wherein the API messages are received and processed by project management service agent 508.

Referring to resource management service 504, data collection module 510 is operable to collect or otherwise retrieve documents, files, records, and other items of data (generally referred to herein as “items”) from one or more data sources. The data sources can include, for example, one or more applications 518a-518p (individually referred to herein as application 518 or collectively referred to herein as applications 518) and one or more repositories 520a-520n (individually referred to herein as repository 520 or collectively referred to herein as repositories 520). Applications 518 can include various types of applications such as SaaS applications, web applications, and desktop applications. Non-limiting examples of applications 518 that can serve as data sources according the present disclosure include collaboration applications such as CONFLUENCE, SLACK, ZOOM, and TEAMS; product/project management applications such as WRIKE, JIRA, BASECAMP, and TRELLO; and social applications such as TWITTER and FACEBOOK. Repositories 520 can include various types of data repositories such as conventional file systems, cloud-based storage services such as SHAREFILE, BITBUCKET, DROPBOX, and MICROSOFT ONEDRIVE, and web servers that host files, documents, and other materials.

Data collection module 510 may utilize APIs provided by the various data sources to collect/retrieve the items therefrom. For example, data collection module 510 may use a REST-based API provided by a SaaS application to collect/retrieve the items therefrom (e.g., a REST-based API provided by CONFLUENCE to collect/retrieve pages from CONFLUENCE). As another example, data collection module 510 may use MICROSOFT GRAPH APIs to collect/retrieve the items from TEAMS. As yet another example, data collection module 510 may use a Web API provided by SLACK to collect/retrieve the items from SLACK (e.g., SLACK documents), and a ZOOM API provided by ZOOM to collect/retrieve items from ZOOM. As another example, data collection module 510 may use a file system interface to collect/retrieve files from a file system. As yet another example, data collection module 510 may use an API to download documents from a cloud-based storage service.

A particular data source 518, 520 can be hosted within a cloud computing environment (e.g., cloud computing environment 506 or a different cloud computing environment) or within an on-premises data center (e.g., an on-premises data center of an organization that utilizes resource management service 504).

The particular data sources 518, 520 from which data collection module 510 can collect/retrieve the items can vary between different organizations. In some embodiments, data collection module 510 can obtain a list of data sources used by a particular organization and/or user. For example, some organizations serviced by resource management service 504 may use JIRA as a project management application whereas other organizations may use TRELLO. As another example, some organizations serviced by resource management service 504 may use CONFLUENCE as a collaboration application whereas other organizations may use TEAMS. As still another example, some organizations serviced by resource management service 504 may use SHAREFILE and BITBUCKET as data repositories whereas other organizations may use MICROSOFT ONEDRIVE. Data collection module 510 can determine from which data sources to collect the items from based on configuration information maintained for the organization and/or user. In some embodiments, data collection module 510 may obtain a list of subscribed resources (e.g., applications and services) for a particular organization via resource feed service 420 of FIG. 4B. Data collection module 510 may also obtain authentication credentials (e.g., user ids and passwords, access tokens, etc.) which may be needed to access one of more of the data sources for collecting the items and other data. In some embodiments, data collection module 510 may use a single sign-on service (e.g., service 422 of FIG. 4B) to access one or more such data sources.

As mentioned previously, data collection module 510 can collect items from data source 518, 520. The collected items may be of various types (or forms) depending on the particular data source 518, 520. For example, data collection module 510 can collect pages and attachments from CONFLUENCE. As another example, data collection module 510 can collect documents from SLACK. As another example, data collection module 510 can collect files from a file system and download documents from a cloud-based storage service. In general, a collected item can include contents, such as text and images, along with metadata and/or other information such as a creator or author of the item (e.g., name and/or user id of a person who created and/or authored the item), a title (e.g., a filename of the item), a timestamp indicating when the item was created, a version (e.g., a version number of the item), a type of content (e.g.,, text, image, computer code, etc.), and tags or keywords added to the item. In the case of an image, the metadata can include information describing the image such as a location of the image, what is being shown in the image, etc. An item may also include attachments, such as files and documents, or links to such materials. These examples of the different types of items and associated metadata and other information are merely illustrative and may vary depending on the capabilities of the particular data source 518, 520.

In some embodiments, data collection module 510 can collect items from data sources 518, 520 on a continuous or periodic basis (e.g., according to a predetermined schedule such as, for example, every 30 minutes, 1 hour, 2 hours, or any other suitable period of time). Additionally or alternatively, a data source (e.g., data source 518, 520) can send or otherwise provide an item to data collection module 510 in response to an even occurring on the data source (e.g., a CONFLUENCE page being published).

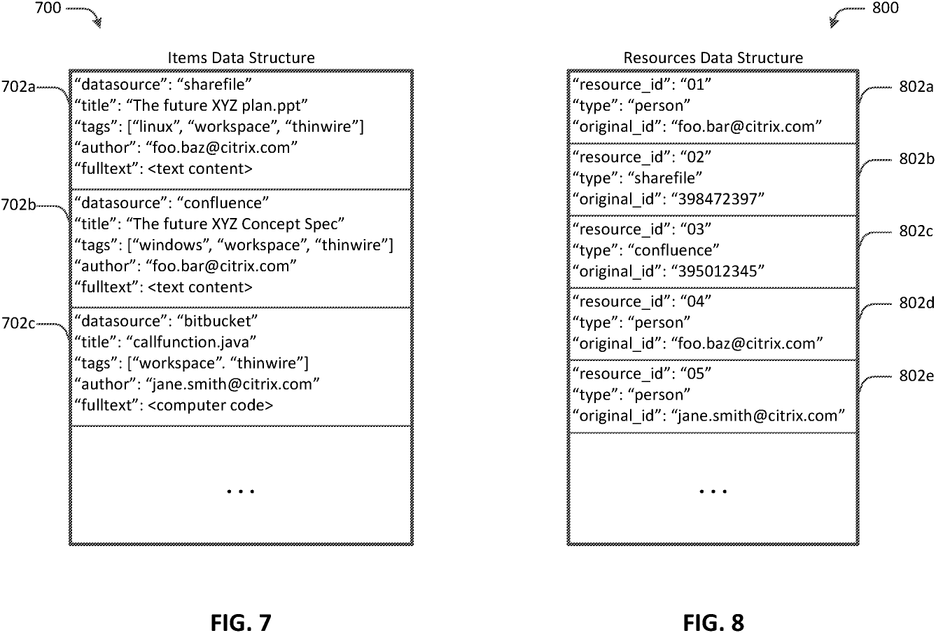

Data collection module 510 can store the items collected from data sources 518, 520 within data repository 512 that can correspond to, for example, a storage service within cloud computing environment 506. In some embodiments, data collection module 510 can store information about the collected items within a data structure such that the information (i.e., data) can be readily used to extract keywords therefrom. More specifically, for a particular item, data collection module 510 can store in the data structure information indicating a data source from which an item was collected from, a name associated with the item such as a filename or any other title, any keywords that are provided with the item, the item’s creator(s), and the actual contents of the item. In the case where an item contains non-text content, such as, for example, image content or other type of binary content, data collection module 510 can store in the data structure metadata or other information that describes the non-text contents (e.g., information that describes the image or picture contained in the item). An illustrative data schema that can be used to store information about the collected items is described below in the context of FIG. 7.

Data collection module 510 can determine or otherwise identify the resources that may be used to augment new tasks from the information stored about the collected items. Non-limiting examples of types of resources include a person resource (e.g., a person), document resource (e.g., a document), file resource (e.g., a file), and computer code (or more simply “code”) resource (e.g., code). In some embodiments, data collection module 510 can categorize the individual collected items as a resource. For example, if the information stored for an item indicates that the item was collected from SLACK, data collection module 510 may categorize the item as a document resource. As another example, if the information stored for an item indicates that the item was collected from a file system, data collection module 510 may categorize the item as a file resource. As still another example, if the information stored for an item indicates that the item was collected from BITBUCKET, data collection module 510 may categorize the item as a code resource. As yet another example, if the information stored for an item indicates that the item was collected from CONFLUENCE, data collection module 510 may use the name of the item and/or the contents of the item to categorize the item as a document resource, a file resource, or a code resource.

In some embodiments, data collection module 510 can identify a creator of a collected item as a resource (e.g., a creator of an item can be identified as a person resource). For example, if the information stored for an item indicates that the item was created by a person having an email address “foo.bar@citrix.com”, data collection module 510 may identify that person as a person resource. In the case where an item is created by two or more creators, data collection module 510 can identify the individual creators as a person resource. For example, if the information stored for an item indicates that the item was created by John Smith and Jane Jones, data collection module 510 may identify John Smith as a person resource and Jane Jones as another person resource.

Data collection module 510 can store information regarding the resources, determined from the collected items, within data repository 512, where it can subsequently be retrieved to augment new tasks created within project management service 502. In some embodiments, data collection module 510 can store information about the resources within a data structure such that the information (i.e., data) can be readily used to determine the resources to augment new tasks created within project management service 502. More specifically, for a particular resource, data collection module 510 can store in the data structure an identifier that uniquely identifies a resource (e.g., an identifier that uniquely identifies the resource within resource management service 504), information indicating the type of resource or where the item corresponding to the resource was collected from, and an original identifier of the resource. For example, for a person resource, data collection module 510 can store in the data structure a unique identifier of the person resource, information indicating that the resource is a person, and an identifier of the person such as a name, email address, or other type of identifier. For a non-person resource (e.g., a document resource, a file resource, or a code resource), data collection module 510 can store in the data structure a unique identifier of the non-person resource, information indicating where the item corresponding to the non-person resource was collected from (e.g., the data source from where the corresponding item was collected from), and an original identifier of the corresponding item, such as a filename or other type of identifier, which identifies the corresponding item in the data source. For example, if the corresponding item was collected from SHAREFILE, an original identifier of the corresponding item may be a SHAREFILE identifier. In some embodiments, for a particular resource, data collection module 510 can also store information that indicates the number of times a resource is used by users (e.g., a count of the number of times users utilized the resource in performing assigned tasks). In such embodiments, as will be further described below, a count of the number of times a resource is utilized may be a factor in determining a relevancy score for a keyword which indicates how relevant the keyword is to the resource. An illustrative data schema that can be used to store information about the resources is described below in the context of FIG. 8.

Data collection module 510 is also operable to identify topics related to the resources, determined from the collected items, and determine how relevant the topics are to the resources. A topic related to a resource may be determined from one or more keywords of the resource. To determine the keywords for a particular resource, data collection module 510 can extract keywords from the information stored about the item from which the particular resource is derived (e.g., the item from which the particular resource was identified). For example, if a resource is a file collected from SHAREFILE, keywords extracted from the stored information about the SHAREFILE file can be used as the keywords for the resource (i.e., the keywords related to the file resource). As another example, if a resource is a person who created a document collected from CONFLUENCE, the keywords extracted from the stored information about the CONFLUENCE document can be used as the keywords for the person (i.e., the keywords related to the person resource).

The keywords for a particular resource may be extracted in an intelligent fashion such that the keywords correspond to relevant topics of or related to the resource rather than simply a list of words found in the contents of the resource (e.g., not simply a list of words found in the contents of the resource). In some embodiments, for a particular resource, data collection module 510 can use the tags or keywords provided with resource when the resource was collected as the keywords for the resource. For example, if a resource is a CONFLUENCE document and keyword A and keyword B were provided as tags with the document, data collection module 510 can use keyword A and keyword B as the keywords for the CONFLUENCE document (e.g., use keyword A and keyword B as the keywords related to the CONFLUENCE document). Note that, in some cases, tags or keywords may not be provided with a resource when the resource is collected by data collection module 510. For such items, data collection module 510 can determine the keywords from the other information about the resource.

In some embodiments, for a particular resource, data collection module 510 can additionally or alternatively extract keywords from the stored information about the resource (e.g., extract keywords from the resource’s title and/or filename, contents, and metadata). To extract the keywords, data collection module 510 can split the resource’s title, filename, contents, etc., on word boundaries, such as spaces, tabs, ad punctuation marks, to create a preliminary list of keywords. Data collection module 510 may then filter the preliminary list of keywords to remove unimportant words (sometimes referred to as “stop words”) to produce the extracted keywords (or “topics”). Examples of stop words in English include “a,” “the,” “is,” “are,” “in,” “about,” etc. Data collection module 510 can utilize one or more lists of stop words to filter the preliminary keywords. In some embodiments, the organization can define a custom list of stop words to be used by data collection module 510 (e.g., the list of stop words can be configured as an organizational policy). In some embodiments, the organization can define a list of keywords and/or topics to be used by data collection module 510. For example, an organization in a particular industry may define a list of key words that are appropriate to the organization’s industry. Data collection module 510 can then extract keywords from the resource based on the defined list of key words. In some embodiments, data collection module 510 can utilize one or more machine learning (ML) algorithms to extract keywords from the resource.

In some embodiments, data collection module 510 can extract keywords from attached and/or linked documents, files, etc., and attribute the extracted keywords to a resource which contained the attachment and/or link. For example, if a resource A’s contents included a link to a page B, data collection module 510 can extract keywords from the contents of page B, and attribute the keywords extracted from page B to resource A. In other words, data collection module 510 can consider the keywords extracted from page B as if those keywords were extracted from resource A, even if resource A’s contents did not contain the keywords extracted from page B.

Upon extracting the keywords from a resource, data collection module 510 can, for a particular keyword extracted from the resource, determine a relevancy score for the keyword. A relevancy score for a keyword indicates the relevancy of the keyword to the resource. In other words, a relevancy score for a keyword (topic) indicates how relevant the keyword (topic) is to a person resource, a document resource, a file resource, and/or a code resource derived from the item.

Data collection module 510 can determine a relevancy score for a keyword using various methods. In one such method, a relevancy score for a keyword may be determined based on the number of times the keyword appears or is found within the resource (e.g., based on the number of times the keyword is found in the resource’s title and/or filename, contents, and metadata). For example, a relevancy score of “1” can be assigned to a keyword if the keyword appears between 1-3 times, an initial relevancy score of “2” can be assigned to a keyword if the keyword appears between 4-5 times, an initial relevancy score of “3” can be assigned to a keyword if the keyword appears between 4-5 times, etc. In another such method, a relevancy score for a keyword can be determined based on where in a resource the keyword is extracted from. For example, a relevancy score of “1” can be assigned to a keyword if the keyword is from an attached or linked page, document , file, etc., a relevancy score of “2” can be assigned to a keyword if the keyword is from the contents or metadata, a relevancy score of “5” can be assigned to a keyword if the keyword is from the title or filename, and a relevancy score of “7” can be assigned to a keyword if the keyword is one of the tags or keywords provided with the resource. Other methods of determining a relevancy score for a keyword may include a combination of the above methods and/or variations thereof. For example, an initial relevancy score for a keyword may be determined based on a count of the number of times the keyword appears in a resource. A final relevancy score can then be determined by adjusting the initial relevant score (e.g., by applying a weight factor) based on where in the resource the keyword is extracted from.

In some embodiments, data collection module 510 can adjust a relevancy score determined for a keyword based on the utilization of a resource. For example, a resource, such as a document resource, a file resource, and a code resource, may be presented to users in the form of a link to the resource. Presenting the resource in this way allows for collecting data (e.g., telemetry data) indictive of the number of times the resource is utilized (e.g., collecting data indicative of the number of times the link is clicked/tapped/selected). The extent to which a resource is utilized may be indicative of the relevancy (or importance) of the resource with respect to the keywords (topics) related to the resource. Data collection module 510 can then adjust a relevancy score determined for a keyword extracted from the resource based on a count of the times the resource is utilized. For example, various weights may be applied to the relevancy score based on the count of the times the resource is utilized.

In some embodiments, in the case where a resource is a person (e.g., a person resource), data collection module 510 can adjust a relevancy score determined for a keyword based the level of expertise of the person in the topic or field represented by the keyword. For example, the expertise of a person in a topic or field represented by a keyword may be determined from the number of resources, such as documents and files, authored or created by the person and which are related to the keyword. A person who authored/created a larger number of documents/files related to a keyword may be deemed more knowledgeable (i.e., more of an expert) in the topic or field represented by the keyword than a person who authored/created a smaller number of documents/files related to a keyword. Data collection module 510 can adjust a relevancy score determined for a keyword extracted from a person resource based on a count of other resources (e.g., documents, files, etc.) authored or created by the person and which are related to the keyword. For example, various weights may be applied to the relevancy score based on the count of other resources (e.g., documents, files, etc.) authored or created by the person and which are related to the keyword.

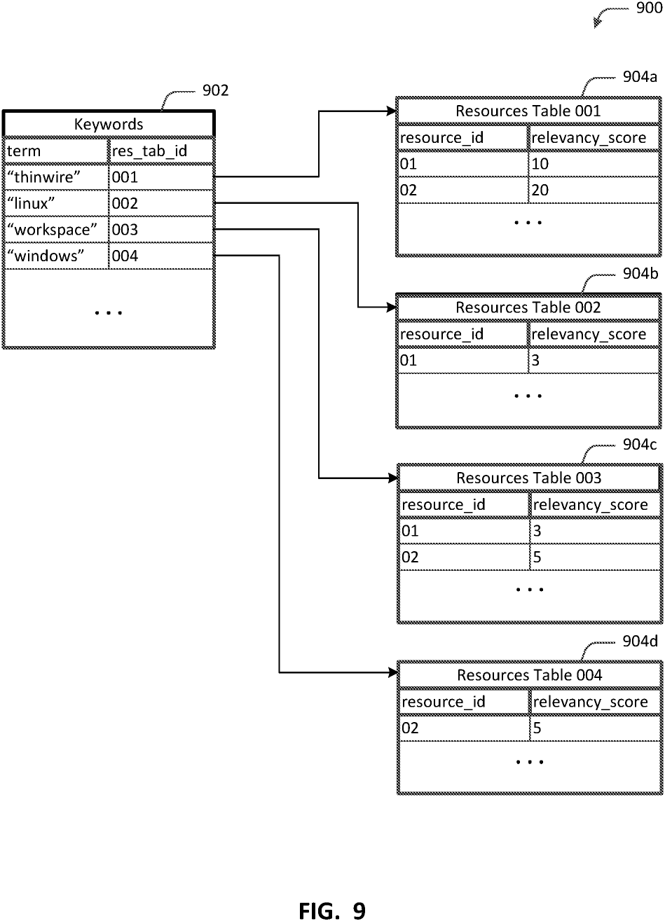

Data collection module 510 can store the keywords extracted from the resources and the relevancy scores for the keywords within data repository 512. In some embodiments, data collection module 510 can store the keywords and the relevancy scores for the keywords within one or more data structures such that the information (i.e., data) can be readily searched to identify keywords and relevancy scores. An illustrative data schema that can be used to store keywords and relevancy scores is described below in the context of FIG. 9.

Project management service module 514 can be provided as a sub-module or other component of resource management service 504. For example, resource management service 504 can utilize project management service module 514 to receive notifications (or “messages”) from project management service 502 when new tasks are created in project management service 502. To this end, in some embodiments, project management service module 514 may be implemented as a webhook that registers with project management service 502 to receive a notification when a new task creation event occurs in project management service 502. A notification of a new task creation from project management service 502 may include information regarding the new task such as an identifier that identifies the new task (e.g., a task id), a status indicator that indicates the status of the new task (e.g., “created”, “assigned”, “augmented”, “completed”, etc.), a title or name of the new task, tags or keywords provided with the new task (e.g., tags/keywords provided by a creator of the new task), an assignee (e.g., a person assigned to perform the new task), and a description of the new task (e.g., text content describing the new task). In response to receiving a notification of a creation of a new task, project management service module 514 can send the information regarding the new task to recommendation module 516 for processing.

Recommendation module 516 can, in response to receiving information regarding creation of a new task from project management service module 514, determine one or more resources that are relevant to the new task. The determined relevant resources can then be recommended to project management service agent 508 for use in augmenting the new task. To this end, in some embodiments, recommendation module 516 can extract keywords from the information about the new task received from or otherwise provided by project management service module 514 (e.g., extract keywords from the new task’s title and/or filename, tags/keywords, and description of the new task). For example, recommendation module 516 may extract the keywords using extraction methods similar to those described herein in the context of data collection module 510.

In some embodiments, recommendation module 516 can apply an importance weight to the extracted keywords based on where in the new task (e.g., where in the information about the new task) the keywords are extracted from. For example, keywords extracted from the title and/or tags of the new tasks can be assigned a higher importance weight than keywords extracted from the description of the new task. Recommendation module 516 can then use the importance weights in determining the resources that are relevant to the new task and which are to be recommended for use in augmenting the new task.

Recommendation module 516 can then search the keywords extracted from the resources for the keywords extracted from the new task. For example, recommendation module 516 can search the one or more data structures storing the keywords extracted from the resources using the keywords extracted from the new task to identify the resources that are related to the keywords extracted from the new task. Recommendation module 516 can then sort (i.e., order) the identified resources based on the relevancy scores of the keywords associated with the individual resources (e.g., sort the search result based on the relevancy scores of the keywords). In some embodiments, recommendation module 516 can sort the identified resources based on a combination of the relevancy scores of the keywords associated with the individual resources and the importance weight of the keywords (e.g., the importance weight applied to the keywords by recommendation module 516). Recommendation module 516 can then send or otherwise provide information regarding the top N (e.g., N=10) most relevant resources to project management service agent 508 for use in augmenting the new task. The value of N may be configurable by the organization and/or the user.

In some embodiments, recommendation module 516 can apply one or more accessibility factors, such as, for example, availability, location, and language, among others, in determining the top N most relevant resources. For example, a person (i.e., a person resource) who is not readily available (e.g., on vacation, etc.) may be moved lower in the sorted list of resources. As another example, a resource that is at the same location (e.g., same facility, same time zone, etc.) as the assignee of the new task may be moved higher in the sorted list of resources. As still another example, a resource that is of the same language as the assignee of the new task may be moved higher in the sorted list as compared to a resource that is of a different language as the assignee of the new task.

In some embodiment, recommendation module 516 may generate a reason or explanation for recommending a resource (e.g., provide a reason the resource is relevant to the new task). For example, one reason may be that a resource is authored /created by a certain person. Another reason may be that, in case of a person resource, the resource worked on or is knowledgeable in the same or similar topics. Another reason may be that a resource is of a common language and/or accessible. Recommendation module 516 can then provide the generated reason or explanation with the top N most relevant resources to project management service agent 508. Note that not all N resources may include a reason or explanation. In other words, a reason or explanation may not be provided for some or all of the N resources.

As mentioned previously, project management service agent 508 can be provided as a sub-module or other component of project management service 502. For example, in some embodiments, project management service agent 508 may be implemented as a plug-in or extension to project management service 502. In response to the information regarding the top N most relevant resources being received, project management service agent 508 can augment the new task with information regarding some or all of the top N most relevant resources. For example, project management service agent 508 may determine which of the top N most relevant resources to use in augmenting the new task based on one or more of the accessibility factors described above in the context of recommendation module 516. Project management service agent 508 can then augment the new task by including the information regarding some or all of the top N most relevant resources in a task ticket corresponding to the new task. In some implementations, project management service agent 508 can update a user interface (Ul) of project management service 502 to present the information regarding the recommended resources with the display of the new task.

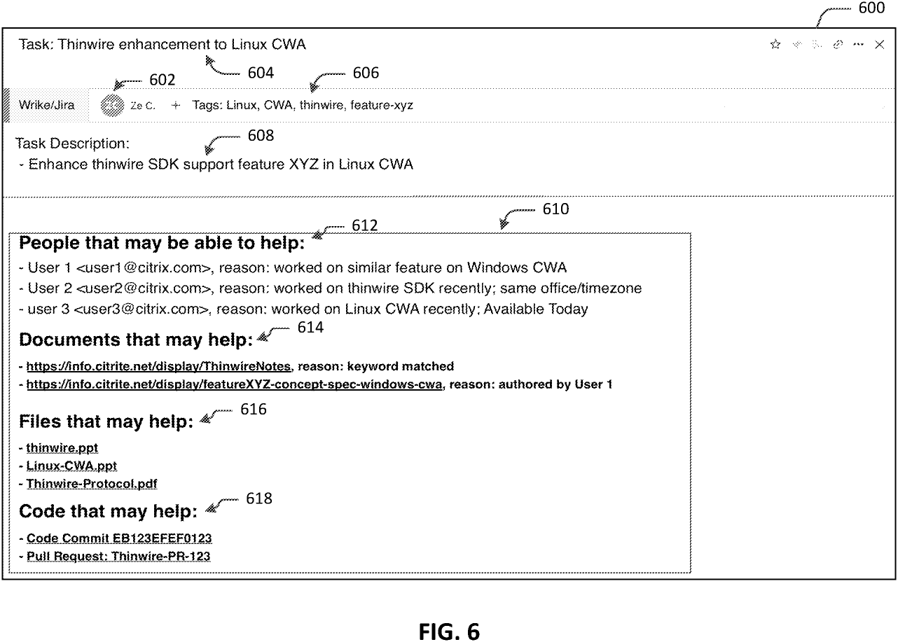

FIG. 6 shows an example of a user interface (UI) 600 that may be used to present information regarding resources that are relevant to a new task, in accordance with an embodiment of the present disclosure. Illustrative UI 600 may be implemented within a project management application/service, such as project management service 502 of FIG. 5. In the example of FIG. 6, UI 600 may be displaying information regarding a new task assigned to a user named “Ze”, as indicated by an icon 602.

As shown, UI 600 can include a title 604 indicating a name of the task (“Thinwire enhancement to Linux CWA”), a tags 606 indicating one or more keywords provided with the new task (“Linux”, “CWA”, “thinwire”, “feature-xyz”), and a description 608 describing the task (“Enhance thinwire SDK support feature XYZ in Linux CWA”). UI 600 can also include a view 610 that displays information regarding one or more resources that are relevant to the task and which may be helpful in performing the task. As can be seen, the display of the information regarding the relevant resources may be organized according to the type of resource, such as person resources 612 (“People that may be able to help:”), document resources 614 (“Documents that may help:”), file resources 616 (“Files that may help:”), and code resources 618 (“Code that may help:”), to allow a user (e.g., Ze) to quickly identify the type of resource.

In view 610, the information displayed regarding one or more person resources may include an email address (e.g., “<user1@citrix.com” for the person resource User 1″) to allow the user to contact the one or more person resources without having to search for their contact information. The information that is displayed regarding one or more document resources may include a link to a document resource (e.g., “https://info.citrite.net/displav/ThinwireNotes”) to allow the user to readily access the document resource(s) without having to search for the document(s). Similarly, the information that is displayed regarding one or more file resources may include a link to a file resource (e.g., “Linux-CWA.ppt”) and the information that is displayed regarding one or more code resources may include a link to a code resource (e.g., “Code Commit EB123EFEF0123”) to allow the user to readily access the file resource(s) and the code resource(s) without having to search for the file(s) and the code. The information that is displayed regarding one or more resources may include a reason for recommending the resource (e.g., “reason: worked on similar feature on Windows CWA”; “authored by User 1”; “keyword matched”; etc.) which allows the user to quickly understand how the resource(s) is related to the new task.

Turning to FIG. 7 and with reference to FIG. 5, an items data structure 700 can be used to store information about items collected or otherwise retrieved by data collection module 510. Illustrative data structure 700 includes one or more records, wherein each record stores information about an item collected from data sources 518, 520. In the example shown, each record in data structure 700 can include the following attributes: a data source from which an item was collected (“datasource”), the item’s filename (“title”), any keywords that were provided with the item (“tags”), the item’s creator (“author”), and the actual contents of the item (“fulltext”). In the case of the contents of an item being non-text such as, for example, an image, the fulltext attribute can be metadata or other information that describes the contents (e.g., information that describes the image or picture contained in the item).

As shown, data structure 700 includes records 702a-703c. Record 702a stores information about an item collected from “sharefile”, with a filename “The future XYZ plan.ppt”, with the provided keywords “linux”, “workspace”, and “thinwire”, created by a person or user having an email address “foo.baz@citrix.com”, and which contains text content. Record 702b stores information about an item collected from “confluence”, with a filename “The future XYZ Concept Spec”, with the provided keywords “windows”, “workspace”, and “thinwire”, created by a person or user having an email address “foo.bar@citrix.com”, and which contains text content. Record 702c stores information about an item collected from “bitbucket”, with a filename “callfunction.java”, with the provided keywords “workspace” and “thinwire”, created by a person or user having an email address “jane.smith@citrix.com”, and which contains computer code.

Turning to FIG. 8 and with reference to FIGS. 5 and 7, a resources data structure 800 can be used to store information about resources derived from the items collected by data collection module 510. Illustrative data structure 800 includes one or more records, wherein each record stores information about a resource. In the example, shown, each record in data structure 800 can include a “resource_id” attribute that uniquely identifies a resource, a “type” attribute that indicates a resource type for the resource (e.g., “person”, “sharefile”, “confluence”, “slack”, “bitbucket”, etc.), and an “original_id” attribute that indicates the resource’s original identifier (e.g., a name, email address, or other type of identifier for a person resource; a filename or other type of identifier for a document resource, a filename or other type of identifier for a file resource; and a filename or other type of identifier for a code resource).

As shown, data structure 800 includes records 802a-802e. Record 802a stores information about a resource identified by a resource identifier “01”, that is of a type “person”, and having an email address “foo.bar@citrix.com” as an original identifier. For example, the person resource identified by the information stored in record 802a may have been identified from the author attribute in record 702b in data structure 700. Record 802b stores information about a resource identified by a resource identifier “02”, that is of a type “sharefile”, and having an original SHAREFILE identifier “398472397”. For example, the file resource identified by the information stored in record 802b may correspond to the item identified by the information stored in record 702a in data structure 700 (e.g., data collection module 510 may have categorized the item identified in record 702a as the resource identified in record 802b). Record 802c stores information about a resource identified by a resource identifier “03”, that is of a type “confluence”, and having an original CONFLUENCE identifier “395012345”. For example, the document resource identified by the information stored in record 802c may correspond to the item identified by the information stored in record 702b in data structure 700. Record 802d stores information about a resource identified by a resource identifier “04”, that is of a type “person”, and having an email address “foo.baz@citrix.com” as an original identifier. For example, the person resource identified by the information stored in record 802d may have been identified from the author attribute in record 702a in data structure 700. Record 802e stores information about a resource identified by a resource identifier “05”, that is of a type “person”, and having an email address “jane.smith@citrix.com” as an original identifier. For example, the person resource identified by the information stored in record 802e may have been identified from the author attribute in record 702c in data structure 700.

Turning to FIG. 9 and with reference to FIGS. 5, 7, and 8, a database schema 900 that can be used to store keywords and relevancy scores determined by data collection module 510. Illustrative schema 900 includes a keywords table 902 and one or more resources table 904a-904d (individually referred to herein as resources table 904 or collectively referred to herein as resources tables 904).

Keywords table 902 can store the keywords extracted by, for example, data collection module 510 from information about one or more of the collected items stored in items data structure 700. In the example shown, keywords table 902 includes the following attributes (or “columns”): a keyword (“term”) and a unique identifier for a resources table (“res_tab_id”). The term attribute, which may be a unique key of table 902, may correspond to a unique identifier of a resources table 904. For example, and as shown in FIG. 9, a first entry (or “row”) in table 902 is for a keyword “thinwire” and corresponds to a unique identifier 0001 that identifies resources table 904a, a second entry in table 902 is for a keyword “linux” and corresponds to a unique identifier 0002 that identifies resources table 904b, a third entry in table 902 is for a keyword “workspace” and corresponds to a unique identifier 0003 that identifies resources table 904c, and a fourth entry in table 902 is for a keyword “windows” and corresponds to a unique identifier 0004 that identifies resources table 904d.

Resources table 904 can store information used to identify, for a given row in keywords table 902, the resources related that keyword (e.g., the resources that contain that keyword) and, for each identified resource, a relevancy score for that keyword which indicates the relevancy of that keyword to the identified resource. In the example shown, resources table 904 includes the following attributes (or “columns”): a unique identifier for a resource (“resource_id”) and a relevancy score for the corresponding keyword in keywords table 902 (“relevancy_score”). For example, and as shown in FIG. 9, table 904a stores information to identify the resources related to the keyword “thinwire” (resource_id:01 and resource_id:02) and, for each identified resource, a relevancy score for the identified resource (relevancy_score:10 for resource_id:01 and relevancy_score:20 for resource_id:2); table 904b stores information to identify the resources related to the keyword “linux” (resource_id:01) and, for each identified resource, a relevancy score for the identified resource (relevancy_score:3 for resource_id:01); table 904c stores information to identify the resources related to the keyword “workspace” (resource_id:01 and resource_id:02) and, for each identified resource, a relevancy score for the identified resource (relevancy_score:3 for resource_id:01 and relevancy_score:5 for resource_id:2); and table 904d stores information to identify the resources related to the keyword “windows” (resource_id:02) and, for each identified resource, a relevancy score for the identified resource (relevancy_score:5 for resource_id:2). The resource_id attribute in resources table 904 may correspond to a unique identifier of a resource in resources data structure 800.

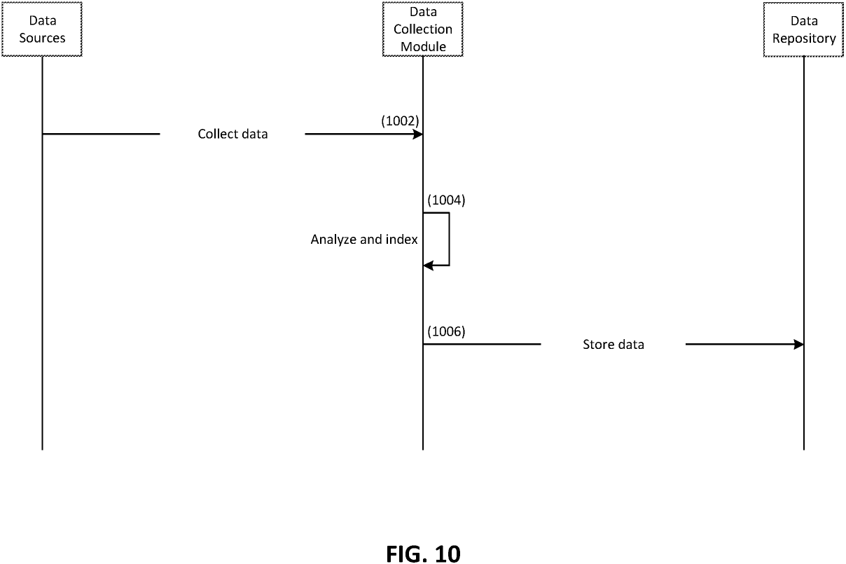

FIG. 10 is a sequence diagram showing an example flow of interactions between various components to collect information regarding resources for use in augmenting a new task, in accordance with an embodiment of the present disclosure. For example, the interactions may be between various components of resource management service 508 of FIG. 5 to collect information regarding resources from one or more data sources (e.g., repositories 518). In some embodiments, resource management service 508 can collect the information from the one or more repositories 518 on a continuous or periodic basis. In some embodiments, the one or more repositories can send the information to resource management service 508 in response to an occurrence of a data storage event (e.g., a confluence page being published).

At 1002, data collection module 510 of resource management service 594 collects items, such as documents, files, records, and other items of data, from one or more data sources. For example, data collection module 510 can collect items from one or more applications 518 and repositories 520. In some embodiments, the items from the data repositories may be collected on a continuous or periodic basis.

At 1004, data collection module 510 analyzes and indexes the collected items. For example, data collection module 510 can determine or otherwise identify one or more resources from the collected items. and, for each resource, extract keywords from the resource. Data collection module 510 can then extract keywords from each resource and determine relevancy scores for the extracted keywords. Data collection module 510 can then index the resources, keywords and relevancy scores.

At 1006, data collection module 510 stores the indexed data (i.e., the indexed resources, keywords and relevancy scores) in data repository 512. For example, data collection module 510 may store the indexed data in one or more data structures.

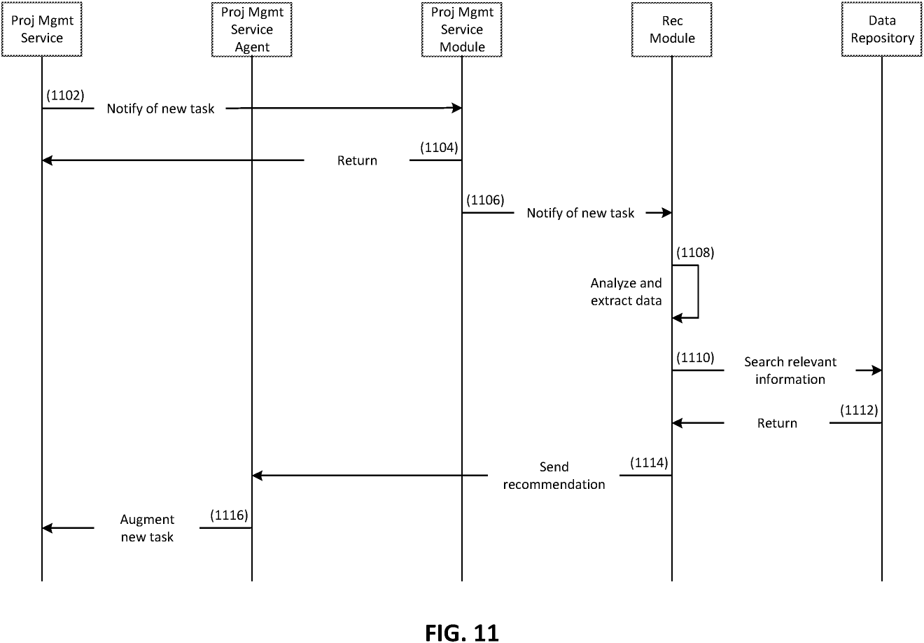

FIG. 11 is a sequence diagram showing an example flow of interactions between various components to augment a new task with information regarding resources relevant to the new task, in accordance with an embodiment of the present disclosure. For example, the interactions may be between various components of task system 502 and resource management service 508 of FIG. 5 in response to a new task being created in task system 502.

At 1102, project management service module 514 of resource management service 504 receives a message from project management service 502 notifying of a creation of a new task in project management service 502. The message may include information regarding the new task that is created in project management service 502.

In response to the message being received, at 1104, project management service module 514 sends a notification of the receipt of the message to resource management service 504.

At 1106, project management service module 514 sends a notification to recommendation module 516 informing of the creation of the new task in project management service 502. The notification may include the information regarding the new task that is created in project management service 502.

In response to the information regarding the new task being received, at 1108, recommendation module 516 analyzes the received information and extracts the data. For example, recommendation module 516 can extract one or more keywords from the information regarding the new task for use in determining resources that are relevant to the new task.

At 1110, recommendation module 516 searches data repository 512 for resources related to the keywords extracted from the information regarding the new task. For example, the data structures storing the keywords extracted from the resources in data repository 512 can be searched using the keywords extracted from the new task to identify the resources that are related to the keywords extracted from the new task.

In response to the search by recommendation module 516, at 1112, data repository 512 returns information regarding the resources that are related to the keywords extracted from the new task to recommendation module 516.

In response to the resources that are related to the keywords extracted from the new task being received, at 1114, recommendation module 516 sends information regarding the top N most relevant resources to project management service agent 508. For example, the top N most relevant resources can be determined from the resources that are related to the keywords extracted from the new task, as previously described herein.

In response to the information regarding the top N most relevant resources being received, at 1116, project management service agent 508 augments the new task with the information regarding some or all of the top N most relevant resources. For example, project management service agent 508 can include information regarding some or all of the top N most relevant resources in a task ticket corresponding to the new task.

### Further Example Embodiments

The following examples pertain to further embodiments, from which numerous permutations and configurations will be apparent.

Example 1 includes a method including: receiving, by a first computing device, information regarding a new task to be performed by a user; extracting, by the first computing device, one or more keywords from the information regarding the new task; identifying, by the first computing device, one or more resources relevant to the new task based on relevancy scores, a relevancy score for a resource indicative of the relevancy of the one or more keywords to the resource; and sending, by the first computing device, information regarding the one or more resources relevant to the new task to a second computing device, the second computing device configured to augment the new task with the information regarding the one or more resources relevant to the new task.

Example 2 includes the subject matter of Example 1, wherein the relevancy of the one or more keywords is based on a count of at least one keyword of the one or more keywords included in the resource.

Example 3 includes the subject matter of any of Examples 1 and 2, wherein the relevancy of the one or more keywords is based on an importance at least one keyword of the one or more keywords to the resource.

Example 4 includes the subject matter of any of Examples 1 through 3, wherein the information regarding the one or more resources includes information identifying another user relevant to performance of the new task.

Example 5 includes the subject matter of any of Examples 1 through 4, wherein the information regarding the one or more resources includes information identifying a file relevant to performance of the new task.

Example 6 includes the subject matter of any of Examples 1 through 5, wherein the information regarding the one or more resources includes information identifying computer code relevant to performance of the new task.

Example 7 includes the subject matter of any of Examples 1 through 6, wherein the information regarding the one or more resources includes, for at least one of the one or more resources, a reason the resource is relevant to the new task.

Example 8 includes the subject matter of any of Examples 1 through 7, further including augmenting, by the second computing device, the new task with information regarding at least one of the one or more resources relevant to the new task.

Example 9 includes a system including a processor and a non-volatile memory storing computer program code that when executed on the processor causes the processor to execute a process operable to: receive information regarding a new task to be performed by a user; extract one or more keywords from the information regarding the new task; identify one or more resources relevant to the new task based on relevancy scores, a relevancy score for a resource indicative of the relevancy of the one or more keywords to the resource; and send information regarding the one or more resources relevant to the new task to another computing device, the another computing device configured to augment the new task with the information regarding the one or more resources relevant to the new task.

Example 10 includes the subject matter of Example 9, wherein the relevancy of the one or more keywords is based on a count of at least one keyword of the one or more keywords included in the resource.

Example 11 includes the subject matter of any of Examples 9 and 10, wherein the relevancy of the one or more keywords is based on an importance at least one keyword of the one or more keywords to the resource.

Example 12 includes the subject matter of any of Examples 9 through 11, wherein the information regarding the one or more resources includes information identifying another user relevant to performance of the new task.

Example 13 includes the subject matter of any of Examples 9 through 12, wherein the information regarding the one or more resources includes information identifying a file relevant to performance of the new task.

Example 14 includes the subject matter of any of Examples 9 through 13, wherein the information regarding the one or more resources includes information identifying computer code relevant to performance of the new task.

Example 15 includes the subject matter of any of Examples 9 through 14, wherein the information regarding the one or more resources includes, for at least one of the one or more resources, a reason the resource is relevant to the new task.

Example 16 includes a method including: sending, by a first computing device, information regarding a new task that is to be performed by a user to a second computing device; receiving, by the first computing device, information regarding one or more resources relevant to the new task from the second computing device, wherein the one or more resources relevant to the new task are identified based on relevancy scores, a relevancy score for a resource indicative of the relevancy of one or more keywords to the resource, the one or more keywords extracted from the information regarding the new task; and augmenting, by the first computing device, the new task with the information regarding the one or more resources relevant to the new task.

Example 17 includes the subject matter of Example 16, wherein the relevancy of the one or more keywords is based on at least one of a count of at least one keyword of the one or more keywords included in the resource or an importance at least one keyword of the one or more keywords to the resource.

Example 18 includes the subject matter of any of Examples 16 and 17, wherein the information regarding the one or more resources includes information identifying another user relevant to performance of the new task.

Example 19 includes the subject matter of any of Examples 16 through 18, wherein the information regarding the one or more resources includes information identifying a file relevant to performance of the new task.

Example 20 includes the subject matter of any of Examples 16 through 19, wherein the information regarding the one or more resources includes information identifying computer code relevant to performance of the new task.

Example 21 includes the subject matter of any of Examples 16 through 20, wherein the information regarding the one or more resources includes, for at least one of the one or more resources, a reason the resource is relevant to the new task.

Example 22 includes a system including a processor and a non-volatile memory storing computer program code that when executed on the processor causes the processor to execute a process operable to: send information regarding a new task that is to be performed by a user to another computing device; receive information regarding one or more resources relevant to the new task from the another computing device, wherein the one or more resources relevant to the new task are identified based on relevancy scores, a relevancy score for a resource indicative of the relevancy of one or more keywords to the resource, the one or more keywords extracted from the information regarding the new task; and augment the new task with the information regarding the one or more resources relevant to the new task.

Example 23 includes the subject matter of Example 22, wherein the relevancy of the one or more keywords is based on at least one of a count of at least one keyword of the one or more keywords included in the resource or an importance at least one keyword of the one or more keywords to the resource.

Example 24 includes the subject matter of any of Examples 22 and 23, wherein the information regarding the one or more resources includes information identifying another user relevant to performance of the new task.

Example 25 includes the subject matter of any of Examples 22 through 24, wherein the information regarding the one or more resources includes information identifying a file relevant to performance of the new task.

Example 26 includes the subject matter of any of Examples 22 through 25, wherein the information regarding the one or more resources includes information identifying computer code relevant to performance of the new task.

Example 27 includes the subject matter of any of Examples 22 through 26, wherein the information regarding the one or more resources includes, for at least one of the one or more resources, a reason the resource is relevant to the new task.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
receiving, by a first computing device, information regarding a new task to be performed by a user;
extracting, by the first computing device, one or more keywords from the information regarding the new task;
identifying, by the first computing device, one or more resources relevant to the new task based on relevancy scores, a relevancy score for a resource indicative of the relevancy of the one or more keywords to the resource; and
sending, by the first computing device, information regarding the one or more resources relevant to the new task to a second computing device, the second computing device configured to augment the new task with the information regarding the one or more resources relevant to the new task.

2. The method of claim 1, wherein the relevancy of the one or more keywords is based on a count of at least one keyword of the one or more keywords included in the resource.

3. The method of claim 1, wherein the relevancy of the one or more keywords is based on an importance at least one keyword of the one or more keywords to the resource.

4. The method of claim 1, wherein the information regarding the one or more resources includes information identifying another user relevant to performance of the new task.

5. The method of claim 1, wherein the information regarding the one or more resources includes information identifying a file relevant to performance of the new task.

6. The method of claim 1, wherein the information regarding the one or more resources includes information identifying computer code relevant to performance of the new task.

7. The method of claim 1, wherein the information regarding the one or more resources includes, for at least one of the one or more resources, a reason the resource is relevant to the new task.

8. The method of claim 1, further comprising augmenting, by the second computing device, the new task with information regarding at least one of the one or more resources relevant to the new task.

9. A system comprising:
a processor; and
a non-volatile memory storing computer program code that when executed on the processor causes the processor to execute a process operable to:
receive information regarding a new task to be performed by a user;
extract one or more keywords from the information regarding the new task;
identify one or more resources relevant to the new task based on relevancy scores, a relevancy score for a resource indicative of the relevancy of the one or more keywords to the resource; and
send information regarding the one or more resources relevant to the new task to another computing device, the another computing device configured to augment the new task with the information regarding the one or more resources relevant to the new task.

10. The system of claim 9, wherein the relevancy of the one or more keywords is based on a count of at least one keyword of the one or more keywords included in the resource.

11. The system of claim 9, wherein the relevancy of the one or more keywords is based on an importance at least one keyword of the one or more keywords to the resource.

12. The system of claim 9, wherein the information regarding the one or more resources includes information identifying another user relevant to performance of the new task.

13. The system of claim 9, wherein the information regarding the one or more resources includes information identifying a file relevant to performance of the new task.

14. The system of claim 9, wherein the information regarding the one or more resources includes information identifying computer code relevant to performance of the new task.

15. The system of claim 9, wherein the information regarding the one or more resources includes, for at least one of the one or more resources, a reason the resource is relevant to the new task.

16. A method comprising:
sending, by a first computing device, information regarding a new task that is to be performed by a user to a second computing device;
receiving, by the first computing device, information regarding one or more resources relevant to the new task from the second computing device, wherein the one or more resources relevant to the new task are identified based on relevancy scores, a relevancy score for a resource indicative of the relevancy of one or more keywords to the resource, the one or more keywords extracted from the information regarding the new task; and
augmenting, by the first computing device, the new task with the information regarding the one or more resources relevant to the new task.

17. The method of claim 16, wherein the relevancy of the one or more keywords is based on at least one of a count of at least one keyword of the one or more keywords included in the resource or an importance at least one keyword of the one or more keywords to the resource.

18. The method of claim 16, wherein the information regarding the one or more resources includes information identifying another user relevant to performance of the new task.

19. The method of claim 16, wherein the information regarding the one or more resources includes information identifying a file relevant to performance of the new task.

20. The method of claim 16, wherein the information regarding the one or more resources includes information identifying computer code relevant to performance of the new task.
